(19) United States
(12) Patent Application Publication
(10) Pub. No.: US 2011/0240473 A1
(43) Pub. Date: Oct. 6, 2011

(54) Dielectrophoretic Cell Chromatography Device with Spiral Microfluidic Channels and Concentric Electrodes, Fabricated with MEMS Technology

(76) Inventors: Haluk Kulah, Ankara (TR); Ata Tuna Ciftlik, Vaud (CH)

(21) Appl. No.: 13/059,985

(22) PCT Filed: Jan. 20, 2009
(86) PCT No.: PCT/TR2009/000005

§ 371 Date: Feb. 21, 2011

(30) Foreign Application Priority Data
Aug. 22, 2008 (TR) 2008/06315

(51) Int. Cl. C25B 7/00; B01D 57/02; C25B 11/02

(52) U.S. Cl. 204/601

(57) ABSTRACT

This dielectrophoretic micro cell chromatography device with concentric electrodes and spiral microfluidic channels, produced according to MEMS technology subject to this invention; is composed of 4 groups of effect electrodes, inlet electrodes, spiral zone and central span, having exterior upper electrode (1), interior sub electrode with 3D geometry (2), upper inlet electrode (3), sub inlet electrode (4), spiral zone (5), central span (6), constant reading point and Insulating wafer (7) as the main components.

### BACKGROUND OF THE INVENTION

Present invention relates to a chromatography device of which intended purpose is biological cell separation, performing dielectrophoresis by concentric electrodes and spiral microfluidic channels produced by micro electromechanical system (MEMS) technology.

### PRIOR ART ABOUT THE INVENTION (PREVIOUS TECHNIQUE)

Dielectrophoretic characteristics of the cells may vary with many condition and disease. This study focuses on variations in these parameters caused by various cancers. By this way, early diagnosis is aimed without using time consuming and expensive genetic analysis methods. Although, there are systems devoted to certain cancer types in literature, they are designed to diagnose single type of cancer (i.e. breast cancer). In addition, while these systems operate qualitatively, they are far from yielding quantitative results. Moreover, complex electrode geometries and complex electric field application methods are used in these systems which restrict stand alone operation.

The devices introduced in the literature do not operate in parallel and individually. Since the analyses are not performed simultaneously and under identical conditions, reliability and reproducibility of the results are decreased.

On the other hand, the device subject to this invention offers a cell chromatography with dielectrophoretic methods. The device performs automated cell separation, using spiral microchannels installed in between two concentric electrodes. By this way, all cells can be subjected to separation synchronously. The device can respond to linear variations in cell parameters as time or displacement separation, a property that increases resolution significantly.

Since the devices are manufactured using Parylene Suspended Channel Technology on glass, they are cheap, demonstrate high reproducibility, and can easily be commercialized. Also, by changing the electric field characteristics, the device can be adjusted to work in single target cell mode. Similarly, by adjustment of the electric field characteristics, the device has the capacity to separate the cells with respect to their size.

By multiple parallel separation channels, the offered device can perform identical and simultaneous separations which increase reliability and reproducibility of the results.

### AIMS FOR DEVELOPMENT OF THE INVENTION

With the development of the dielectrophoretic micro cell chromatography device with concentric electrodes and spiral micro fluidic channels fabricated with MEMS technology subject to this invention, a device that;
provides high resolution
fast
is produced inexpensively
has less usage costs
low sample consumption
enabling parallel, simultaneously and in equal conditions separation
can be produced in high reproducibility
small and portable
is single use
can work without requiring complex and expensive additional equipments
can be used in diagnosis and treatment process of diseases such as cancer, anaemia which can be determined by cell separation
will enable multipurpose usage through changes in voltage and frequency spectrum of applied potential.
   is aimed.

The innovation offered by the main topics given above provided for the existing machines and systems according to the previous technique can be explained as follows:
The device developed with this invention provides high resolution through using spiral micro fluid channels installed in the concentric electrodes, converting the variations in cell parameters to logarithmic separation time.
By means of the high resolution provided, it can be used in separation of cancer cells whose parameters are very close to normal cells.
Again by means of the high resolution provided, it may reduce diagnosis time for certain diseases, which implies the increase of possibility and success of early diagnosis.
As it works fast, it can be utilized as a tool to determine the effectiveness of existing treatment methods (like chemotherapy), which in turn accelerates the treatment process. Existing expensive and limited diagnosis and analysis methods prevent physicians to perform these controls frequently in the treatment period.
As it can be fabricated with a very low cost, the device will increase the access of the individuals and hospitals. Also low operational cost of the device will reduce the fixed and operational costs of diagnosis.
Owing to the fact that the device consumes very low sample volumes to obtain a result, surgical operations can be kept at minimum levels.
Thanks to simultaneously and equal conditioned separation feature, inaccuracies resulted from variations in ambient conditions (sample amount, heat, liquid conductivity etc.) will be controlled and highly reliable results can be obtained.
High reproducibility of production reduces the time and cost for the post production calibration and quality control.
Its features such as being small and portable, disposable, able to operate without requiring expensive and complex external equipments simplifies the device to be used integrated to remote health centres or military units.

### THE DESCRIPTION OF THE FIGURES EXPLAINING THE INVENTION

The figures prepared and annexed for a better explanation of the dielectrophoretic micro cell chromatography device with concentric electrodes and spiral micro channels, fabricated with MEMS technology subject to this invention are as follows:

FIG. 1—Plan view of the dielectrophoretic micro cell chromatography device with concentric electrodes and spiral micro channels, produced according to MEMS technology

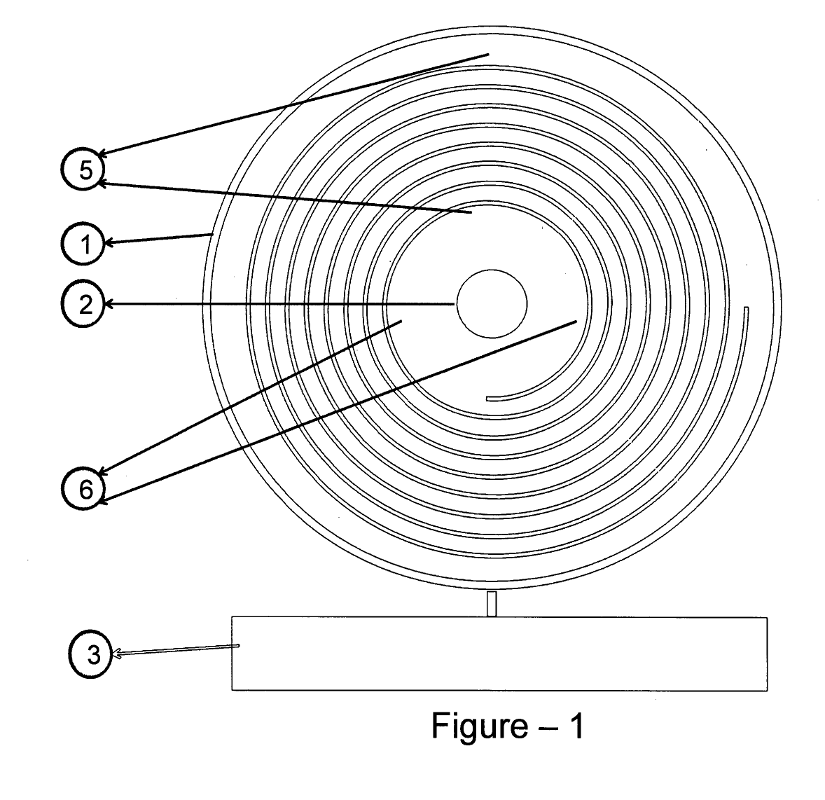

FIG. 2—Reverse perspective view of the effect electrodes

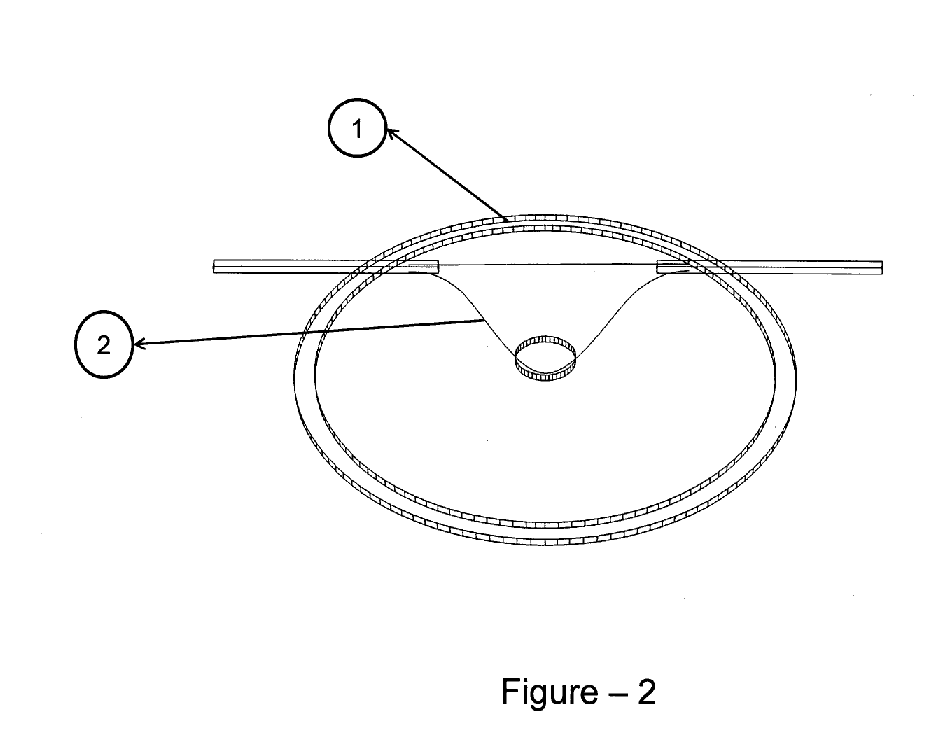

FIG. 3—Section view of the dielectrophoretic micro cell chromatography device with concentric electrodes and spiral micro channels, produced according to MEMS technology

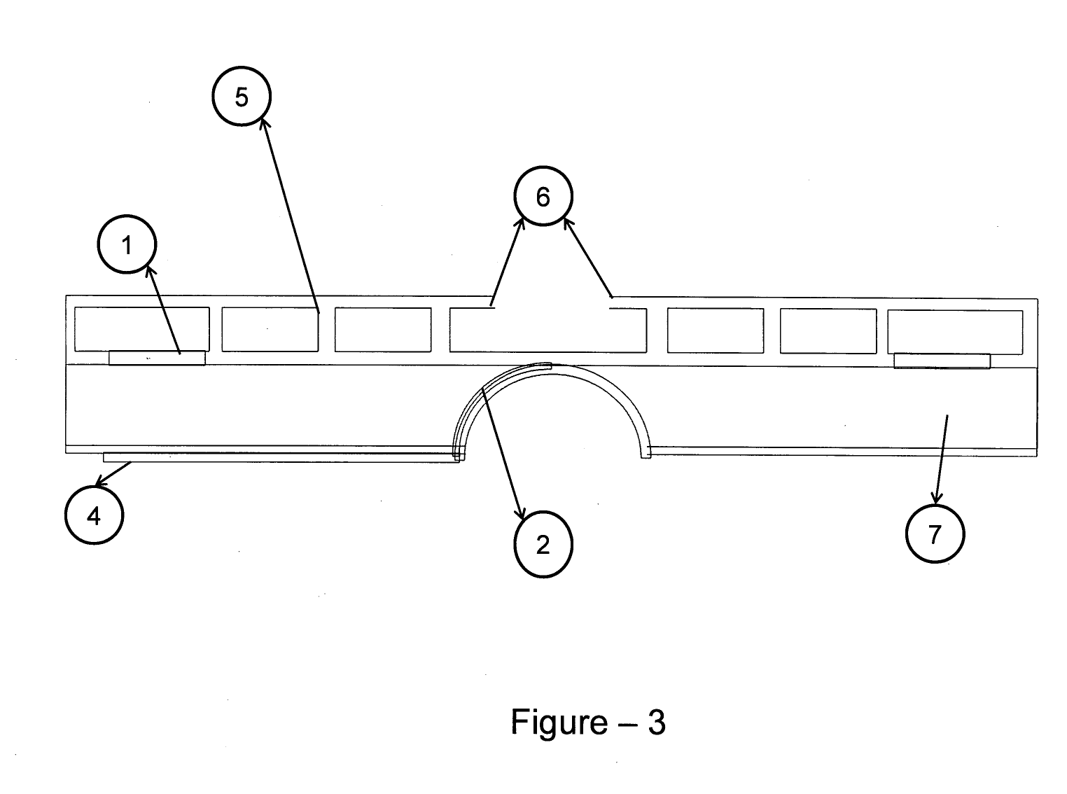

### DESCRIPTION OF THE FEATURES OF THE INVENTION

The components shown in the figures prepared for a better explanation of the dielectrophoretic micro cell chromatography device with concentric electrodes and spiral micro channels, fabricated with MEMS technology improved with this invention are numbered separately and explanation of each number is given below. The illustrations are also made with colour and these parts are also numbered. Explanation of each component numbered is also given below. Additionally some parts that may hardly be understood are given separately illustrated on the figures.
1—Exterior upper electrode
2—Interior sub electrode with 3D geometry
3—Upper inlet electrode
4—Sub inlet electrode
5—Spiral Zone
6—Central span
7—Insulating wafer

### DETAILED DESCRIPTION OF THE INVENTION

The main parts of the dielectrophoretic micro cell chromatography device with concentric electrodes and spiral microfluidic channel, produced according to MEMS technology improved with this invention are of 4 groups of;
Effect electrodes
Inlet electrodes
Spiral Zone
Central span

Effect electrodes are composed of exterior upper electrode (1) and interior sub electrode with 3D geometry (2) components. These electrodes are of metal film and located concentrically. Interior sub electrode with 3D geometry (2) is of parabolic structure and located towards the span at the back of the Insulating wafer (7). Exterior upper electrode (1) is located in form of a plane ring at the upper side of the spacer.

The inlet electrodes designed to apply voltage to the effect electrodes from outside are composed of Upper inlet electrode (3) and Sub inlet electrode (4). These electrodes are of metal film and while the Upper inlet electrode (3) is located at the upper side of the Insulating wafer (7), Sub inlet electrode (4) is located under the Insulating wafer (7). Both inlet electrodes have planar geometry.

Top view of the Spiral Zone (5) illustrates that, it is located between Exterior upper electrode (1) and Interior sub electrode with 3D geometry (2) and comprise micro fluidic channels with spiral geometry. These fluidic channels are located at the upper side of the Insulating wafer (7). The channels are separated from each other with non conductor polymer. Superior and inferior parts of these channels are in closed position.

Central span (6) is also a channel with a span at the superior part. Here is used to fill liquid inside the channel by capillary action and for sample cell installation procedures.

### Working Principle

The device is connected to the inactivated potential source through the inlet electrodes (3 and 4). Next, applying capillary force, microfluidic channels are filled with isotonic cell solution from the central spans (6). Afterwards, the cell culture prepared or heparinized blood samples are dropped in the central spans (6). Later, in accordance with the type of the application, the potential source of alternating or direct current is started.

As the voltage is applied, firstly the cells are pulled towards the inner walls where the spiral micro fluidic channels begin. After this stage, separation starts. Within time, in connection with the differences in dielectrophoretic characteristics and due to the concentric electrodes geometry, different cells exposed to different forces and eventually start to be separated. Banding together, the cells with similar features shall stay ahead or behind in accordance with their dielectric properties.

The cells are monitored through the separation, by sensors using given electrical or optic methods at a constant point. These sensors record the time of cell arrival through preset constant reading point by quantitative and qualitative methods. At the end of the separation, a chromatograph of the cell arrival time is obtained.

As for the separation held simultaneously and in equal conditions, two or more different samples are separated in two or more channels, side by side and having equal conditions, applying same procedure. The chromatographs obtained are analyzed comparatively.

Apart from these, it is possible to conduct reference separation using micro spheres with known electrical features. This method can be used to rank the separations which have to be conducted in different time and conditions. The micro spheres of known features are mixed in both samples and separation is conducted. The chromatographs obtained are ranked as to the position of the spheres and they are compared.

1- The device used in cell separation by dielectrophoretic method, fabricated with MEMS technology, having concentric electrodes and spiral microfluidic channels, characterized with having 4 groups as;
1—Effect electrodes
2—Inlet electrodes
3—Spiral Zone (5)
4—Central span (6)

2- The device used in cell separation by dielectrophoretic method, fabricated with MEMS technology, having concentric electrodes and spiral microfluidic channels of claim 1; characterized in having interior spiral zone (5) and effect electrodes in order to apply the intended electric field to the cells.

3- The device used in cell separation by dielectrophoretic method, fabricated with MEMS technology, having concentric electrodes and spiral microfluidic channels of claim 2; characterized in having effect electrodes of exterior upper electrode (1) and interior sub electrode with 3D geometry (2) located respectively on and beneath of the Insulating wafer (7).

4- The device used in cell separation by dielectrophoretic method, fabricated with MEMS technology, having concentric electrodes and spiral microfluidic channels of any of the claims above; wherein the exterior upper electrode (1) is in form of plane ring, interior sub electrode with 3D geometry (2) is of parabolic structure and located towards the span at the rear of the Insulating wafer (7) and the effect electrodes are formed as these are located concentrically.

5- The device used in cell separation by dielectrophoretic method, fabricated with MEMS technology, having concentric electrodes and spiral microfluidic channels of any of the claims above; characterized in having covert spiral zone, comprising microfluidic channels separated by polymer walls, located between exterior upper electrode (1) and interior sub electrode with 3D geometry (2) and at the upper side of the Insulating wafer (7).

6- The device used in cell separation by dielectrophoretic method, fabricated with MEMS technology, having concentric electrodes and spiral microfluidic channels of any of the claims above; characterized in having Central Span (6) located between exterior upper electrode (1) and interior sub electrode with 3D geometry (2) and at the centre of spiral zone, upper part is of microfluidic channels, used to fill liquid inside the channel by capillary force and for sample cell transition procedures.
